(19) United States
(12) Patent Application Publication
(10) Pub. No.: US 2025/0326499 A1
(43) Pub. Date: Oct. 23, 2025

(54) SYSTEM AND METHOD FOR ADJUSTING FORCES ON ROTATING BODY USING AERODYNAMIC MEANS

(71) Applicant: SHENYANG JIDONG TECHNOLOGY CO., LTD, Shenyang (CN)

(72) Inventors: Jun JIANG, Shenyang (CN); Xuezhu WANG, Shenyang (CN)

(73) Assignee: SHENYANG JIDONG TECHNOLOGY CO., LTD, Shenyang (CN)

(21) Appl. No.: 19/254,508

(22) Filed: Jun. 30, 2025

Related U.S. Application Data
(63) Continuation of application No. PCT/CN2023/142971, filed on Dec. 28, 2023.

(30) Foreign Application Priority Data
Dec. 30, 2022 (CN) 202211736045.6

(51) Int. Cl. B64F 5/60; F16M 11/12; F16M 11/18

(52) U.S. Cl. CPC B64F 5/60; F16M 11/126; F16M 11/18; F16M 2200/066

(57) ABSTRACT

A system for adjusting forces on a rotating body using aerodynamics means includes an aerodynamic component, a sensing system, and a control unit. The aerodynamic component includes at least one support component. At least one aerodynamic driving device is provided on the support component. The support component includes a supporting body, and the aerodynamic driving device is provided on the supporting body. The sensing system includes a system state sensing subsystem.

### CROSS REFERENCE TO RELATED DISCLOSURES

The present application is a continuation-application of International (PCT) Patent Application No. PCT/CN2023/142971 filed on Dec. 28, 2023, which claims priority benefits to Chinese Patent Disclosure No. 2022117360456, filed on Dec. 30, 2022, the contents of which are incorporated herein by reference.

### TECHNICAL FIELD

The present disclosure relates to the technical field of rotating systems, particularly relates to an aerodynamic force adjustment system and a method thereof.

### BACKGROUND

Rotational systems are widely used in industry, scientific research, and training due to advantages like their compact structure and small footprint. They are receiving increasing attention for their capabilities: providing constant or variable speeds over extended periods, delivering a wide range of initial velocities, or generating centrifugal forces of a certain magnitude.

### SUMMARY

A first aspect of the present disclosure provides system for adjusting forces acting on a rotating body using aerodynamic means. The system includes: an aerodynamic component including at least one support component, the at least one support component including at least one aerodynamic driving device; a state sensing system configured to obtain a motion state of the system; and a control unit, the aerodynamic component and the state sensing system being respectively electrically connected to the control unit, and the control unit configured to control the aerodynamic component to reach a desired state according to an information obtained by the state sensing system.

A second aspect of the present disclosure provides a method for adjusting a force on a rotating body. The method includes: rotating the system about a rotation axis; obtaining state information of a force and/or torque of the system on a force monitoring point in response to the system being in a rotating state; performing a force analysis on the state information to obtain dynamic information for adjustment; sending the dynamic information to an aerodynamic component to cause the aerodynamic component to reach a desired attitude and generate the desired force and/or torque; and adjusting an undesirable torque of at least a part of the system in response to the system being in the rotating state.

### BRIEF DESCRIPTION OF THE DRAWINGS

FIG. 1 is a perspective view of an overall structure according to one aspect of the present disclosure.

FIG. 2 is a perspective view of a two-degree-of-freedom attitude adjustment device according to one aspect of the present disclosure.

FIG. 3 is a perspective view of a three-degree-of-freedom attitude adjustment device according to one aspect of the present disclosure.

FIG. 4 is a perspective view of a typical force analysis diagram according to one aspect of the present disclosure.

FIG. 5 is a schematic view of a force analysis diagram of a first implementation according to one aspect of the present disclosure.

FIG. 6 is a schematic view of a force analysis diagram of a first implementation of one aspect of the present disclosure.

FIG. 7 is a perspective view of Embodiment 1 according to one aspect of the present disclosure.

FIG. 8 is a perspective view of Embodiment 2 according to one aspect of the present disclosure.

FIG. 9 is a schematic view of a force analysis diagram of a second implementation according to one aspect of the present disclosure.

FIG. 10 is a schematic view of a force analysis diagram of a second implementation according to one aspect of the present disclosure.

FIG. 11 is a perspective view of Embodiment 3 according to one aspect of the present disclosure.

FIG. 12 is a schematic view of a force analysis diagram of a third implementation according to one aspect of the present disclosure.

FIG. 13 is a schematic view of a force analysis diagram of a third implementation according to one aspect of the present disclosure.

FIG. 14 is a perspective view of Embodiment 4 according to one aspect of the present disclosure.

FIG. 15 is a perspective view of Embodiment 5 according to one aspect of the present disclosure.

FIG. 16 is a perspective view of an aerodynamic braking structure according to one aspect of the present disclosure.

### Detailed Way

The present disclosure will be further explained below in conjunction with specific implementation schemes, but they are not intended to limit the scope of the present disclosure. The structures, proportions, sizes, etc. illustrated in the drawings of the specification are provided to facilitate understanding of the contents disclosed in the specification for those skilled in the art. They do not constitute limitations on the embodiments that may be implemented under the present disclosure and hold no substantial technical significance. Any structural modifications, proportional changes, or dimensional adjustments should still fall within the scope of the technical content disclosed in the present disclosure without affecting the achievable effects purposes of the present disclosure. The terms such as “upper”, “lower”, “front”, “back”, “middle” and the like cited in this specification are only for descriptive clarity, and are not intended to limit the scope of the present disclosure. Alterations or adjustments to these relative positional relationships are also encompassed within the scope of the present disclosure, provided the core technical content remains unchanged.

Taking one application of a rotational system as an example, such a system may provide a to-be-launched aircraft with a substantial range of initial energy. However, during the rotational motion, only the torque about the rotational axis must be borne by the system, which is also relatively easier to achieve in design. In contrast, the centrifugal force generated during rotation, the gravity of the launched aircraft itself, and the self-generated aerodynamic forces of the aircraft introduce additional, undesired torques into the system. These undesired torques, perpendicular to the rotational axis, are often detrimental as they manifest in the form of toppling the rotational axis; hence, they are termed “undesired torque” here. This necessitates that the support structure of the rotary launch system possesses extremely high structural strength, leading to excessive system weight. Such weight is often impractical in real-world applications. Furthermore, the forces acting on the launch system undergo significant abrupt changes when the launched aircraft separates from the rotational system. This makes it very difficult for traditional counterweight trimming methods to effectively accomplish the trimming task. Additionally, traditional counterweight trimming struggles to decouple multidimensional relationships and cannot simultaneously satisfy trimming requirements across multiple dimensions. For instance, it is challenging to concurrently satisfy centrifugal force trimming along the direction of the rotating arm and torque trimming (acting on the rotating arm) along the gravity direction. The above weaknesses severely undermine the benefits offered by rotary launching, significantly restrict its applicability, and thus constrain its development.

The present disclosure employs aerodynamic technology to provide trimming forces for the rotational system. Here, “trimming force” refers to a force or torque specifically applied to eliminate or reduce the system's inherent undesired torque, rather than the strictly mechanical sense of achieving zero net force and net torque in all dimensions. This force adjustment system may be applied to the rotary launching and recovery of aircrafts, to rotating simulation capsules, or to any other devices where this force adjustment system may provide trimming forces. Utilizing a multi-degree-of-freedom attitude adjustment device and an aerodynamic driving device, this force adjustment system provides trimming conditions that simultaneously satisfy requirements across multiple dimensions. The following description takes rotary aircraft launching as an application example. Typically, a rotary launch system incorporates a dedicated drive unit at the rotational axis to provide driving torque to the rotating portion. When required, the trimming end may utilize the aircraft's own power to provide all or part of the driving torque needed for the rotary launch. This rotational power may be a driving force that accelerates the rotation along the rotational axis or a braking force that decelerates it. The force generated by the aerodynamic components of this force adjustment system achieves a combined trimming and driving force-simultaneously satisfying all or part of the driving force required by the rotary launch system and the trimming force required by the system.

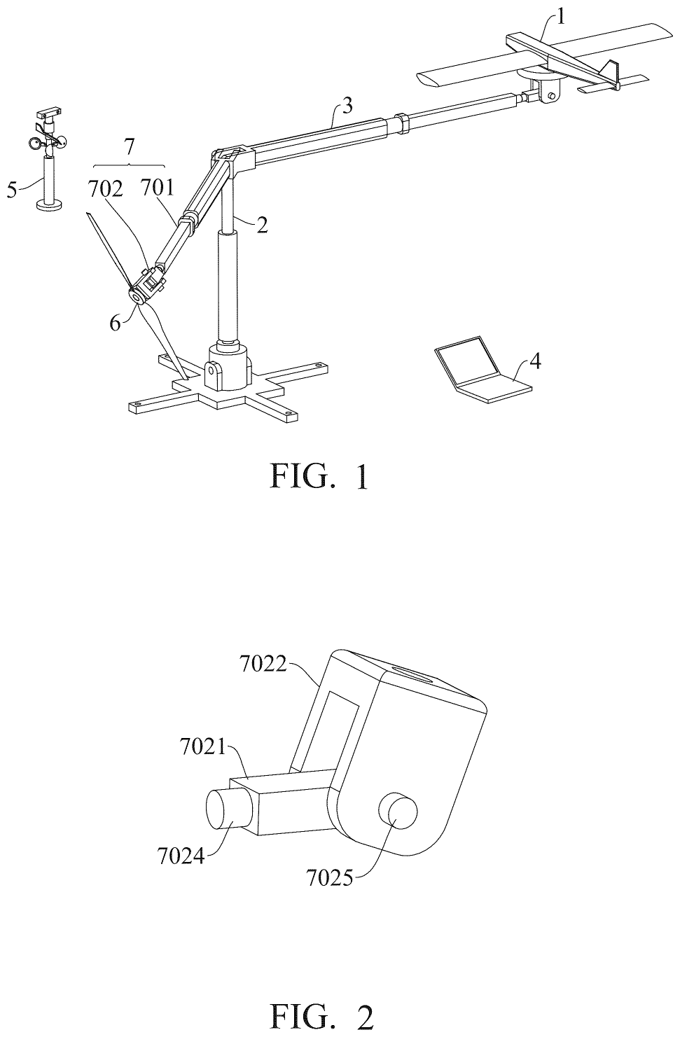

As shown in FIG. 1, a system for adjusting forces proposed in the present disclosure includes an aerodynamic component, a sensing system that provides environmental information and monitors the operating status of all system components, and a control unit 4.

The present disclosure adopts aerodynamic technology to provide trimming and driving force. The aerodynamic component includes an aerodynamic driving device 6 that generates force based on aerodynamic principles, and a support component 7 that provides an attitude for the aerodynamic driving device. The aerodynamic driving device 6 includes one or a combination of several of the following: a propeller, a helicopter propeller and its rotor head, an asymmetric layout and a propeller that generates torque based on non-uniform speed, a wing segment, a deformable wing, an aircraft-type aerodynamic body, a turbine engine, a ducted engine, and a driving device that generates force and torque based on aerodynamic principles such as compressed air injection and chemical fuel injection (including multiple pieces).

The support component includes a support body, and the aerodynamic driving device is arranged on the support body. The support body may be independently designed and independently controlled, or it may be implemented by utilizing other qualified structures of the adaptation system, thereby avoiding system redundancy. For example, as shown in the embodiment in FIG. 1, it employs an independent trimming arm 701, or uses the structure of an original rotating system as a support body. In some embodiments, the aerodynamic driving device may reciprocate along the radial direction of the rotation center, or/and swing up and down, flexibly providing a desired position and attitude for the aerodynamic driving device. For example, the support body incorporates a retractable mechanism, and the aerodynamic driving device is arranged at an end of the support body; or, the support body is provided with a guide rail and a sliding seat that may slide along the guide rail, and the aerodynamic driving device is arranged on the sliding seat.

For clarity of explanation, the support body described hereafter is implemented by a trimming arm 701.

In some embodiments, to enhance the attitude adjustment capability of the aerodynamic driving device 6, a servo-controlled multi-degree-of-freedom (MDOF) attitude adjustment device 702 is mounted on the trimming arm 701. The aerodynamic driving device 6 is then installed on the attitude adjustment device 702.

The attitude adjustment device 702 is configured to adjust the attitude of the aerodynamic driving device 6, enabling the aerodynamic driving device 6 to provide a better trimming force in each working stage of the rotation process. The working stages here include accelerated rotation, decelerated rotation, uniform rotation, and load mutation.

The attitude adjustment device 702 includes a servo system including at least one revolute joint, each revolute joint is driven by a servo or a mechanical linkage. The attitude of the aerodynamic driving device 6 is regulated by adjusting the angle of one or more axes on the attitude adjustment device 702. In some embodiments, the attitude adjustment device 702 includes at least one revolute joint or a combination of several revolute joints for adjusting the yaw angle of the aircraft 1. In some embodiments, the attitude adjustment device 702 includes one revolute joint or a combination of several revolute joints for adjusting the pitch angle of the aircraft 1.

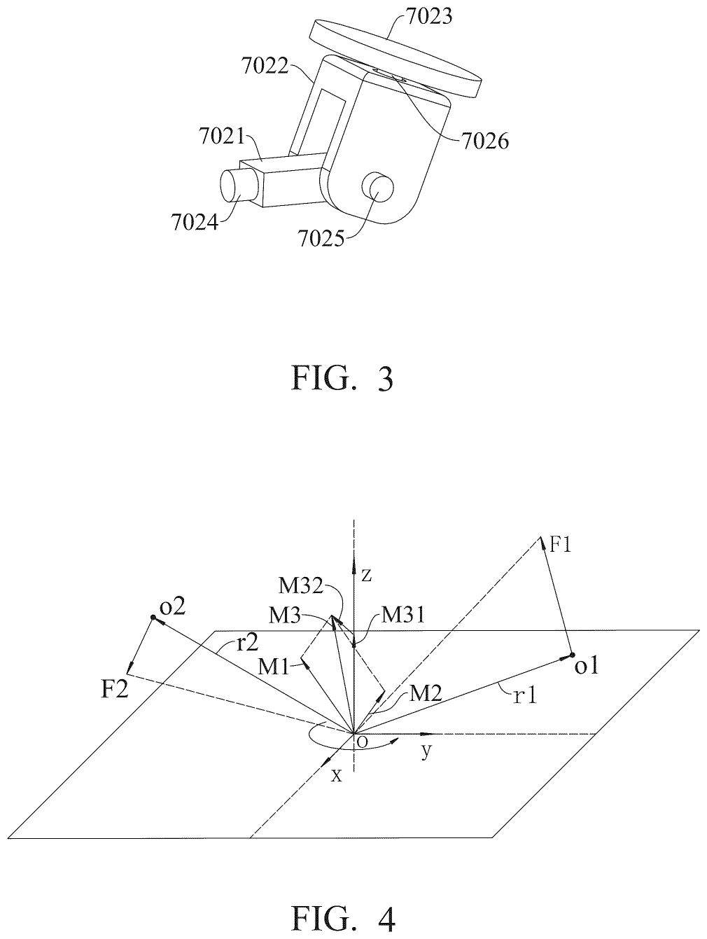

As shown in FIG. 2, in some embodiments, the attitude adjustment device 702 includes two connecting rods connected in sequence by a revolute joint. A first connecting rod 7021 is connected to the trimming arm 701 by the first revolute joint 7024. An axis of the first revolute joint 7024 is a radial direction of a rotation center. The first connecting rod 7021 is connected to the second connecting rod 7022 by a second revolute joint 7025. An axis of the second revolute joint 7025 is perpendicular to the axis of the first revolute joint 7024. The aerodynamic driving device 6 is fixedly connected to the second connecting rod 7022, which may realize the position and attitude of the central symmetric aerodynamic driving device. For a non-central symmetric aerodynamic driving device, as shown in FIG. 3, the second connecting rod 7022 is connected to a third connecting rod 7023 by a third revolute joint 7026. An axis of the third revolute joint 7026 is perpendicular to the axis of the second revolute joint 7025, and the aerodynamic driving device 6 is arranged on the third connecting rod 7023. The first revolute joint 7024, the second revolute joint 7025, and the third revolute joint 7026 are all driven by a servo drive or a mechanical linkage or a combination of servo drive and mechanical linkage.

In some embodiments, the trimming arm 701 that provides a position for the aerodynamic driving device 6 may move about a rotation center, may play a part of the function of the attitude adjustment device 702, and is also regarded as a part of the attitude adjustment device 702.

In some embodiments, the aerodynamic component is provided with at least one support component 7, and each support component 7 is provided with at least one aerodynamic driving device 6. Multiple support components 7 and aerodynamic driving devices 6 are configured to operate cooperatively to achieve a desired trimming state.

The sensing system includes a system state sensing subsystem, which is configured to obtain an operating state of each component of the system. The system state sensing subsystem includes a sensor for obtaining a motion state of each component of the system, such as a gyroscope, an accelerometer, an electromagnetic compass, a force sensor, an encoder, etc.

In some embodiments, the sensing system further includes an environmental information sensing subsystem 5, which is configured to sense an external environmental information and provide effective environmental information for the control of the force adjustment system. The environmental information sensing subsystem 5 includes a sensor that may sense the external environmental state of the system, such as a sensor that measures wind speed, wind direction, temperature, humidity, pressure, and rainfall.

A control unit 4 is configured for various control parameters and variables required by the force adjustment system, controls the support component 7 and the aerodynamic driving device 6 to reach the desired state. The control unit 4 is electrically connected to the support component 7, the aerodynamic driving device 6, and the sensing system. The control unit includes an independent controller of the force adjustment system or/and a controller on the rotation system equipped with the force adjustment system.

The following are some of the embodiments. First, the force analysis diagram of the rotary launch system of an aircraft 1 under normal circumstances is as follows.

Unless otherwise specified, the symbols of the forces and moments mentioned below all represent vectors.

As shown in FIG. 4 (a representative diagram in the embodiment), the origin o of the oxyz Cartesian coordinate system is located at the force analysis point of the system. The force analysis point here refers to the “root” of the system's rotation axis 2, and the z axis aligns with the rotation axis of the rotary launch system. The main reason for selecting o as the force analysis point is that it is usually greatly affected by adverse torques. Furthermore, during implementation, a driver is often installed here, and the strength here is relatively weak compared to the structural strengths of other parts.

In the absence of F2, only the moment M1 acts, then the component of M1 within the oxy plane is often excessively large, which is manifested as an overturning moment that exceeds the system structure's tolerable limit, causing the vertical axis to topple. Alternatively, under the action of a small-magnitude overturning moment with a long period of time, material fatigue fracture is prone to occur at the force analysis point o. The discussion on the torque bearing capacity about the z-axis is omitted here, because the torque about the z-axis is an inherent load that the system must bear and its structural design is easy to implement.

o1 is the equivalent action point of the aircraft. r1 is the vector from the force analysis point o to the equivalent action point o1. F1 is the equivalent force of the aircraft. Then, M1 is the moment exerted by the aircraft to the force analysis point o.

o2 is the equivalent action point of the trimming end. r2 is the vector from the force analysis point o to the equivalent action point o2. F2 is the equivalent force of the trimming end. Then, the torque M2 is the moment exerted by the aircraft to the force analysis point o.

M3 is the vector sum of M1 and M2. Its component along the Z-axis is M31, and its component perpendicular to the z-axis is M32. Designing F2 such that M32 is less than the system's tolerable moment is the technical problem to be solved by the present disclosure.

The resultant moment M3 (sum of M1+M2) includes only two components: M31 and M32. M31 is the torque about the rotation axis, which is the torque that the system must bear, and is not the focus of the present disclosure. M32 is the torque that produces “bending moment”, i.e., the overturning moment mentioned above, which has a greater impact on the system and may also be called “unfavorable moment”, which is the torque of focus in the present disclosure. The purpose of applying the trimming force is to ensure M32 remains below the maximum tolerable value of the system.

As mentioned above, the torque about the z-axis is the force that the system rotation axis 2 must withstand, and it is easy to meet the requirements in design. Therefore, it is not the focus of the present disclosure. The present disclosure mainly discusses the following two situations.

1) In the resultant moment M3 (M1+M2), M32 is not 0. M32 is less than the tolerable value of the system about the x and y axes. M31 and the system torque M4 about the Z axis act concurrently about the z axis. It corresponds to the generalized force scenario shown in FIG. 4. As the baseline condition, “M32 is less than the tolerable value of the system” is the minimum design standard and may also be adopted as a verification criterion for practical systems.

2) In the resultant moment M3 (M1+M2), M32 is 0, leaving only the M31. M31 and the system's Z axis torque M4 act concurrently on the z axis. This situation represents a common pursued design target and is generally established as a design standard. In practical applications, if the system is not capable of strictly achieving “M32 is 0”, the scenario “1)” may be used as the verification criterion for the design.

Without loss of generality, the present disclosure takes an inverted L-shaped rotating body for launching an aircraft as an example. The inverted L-shaped rotating body includes a column and a beam. The axis of the column serves as the rotation axis (z axis) of the rotary launch, and the beam is designed as the launch arm 3 or the trimming arm 701 of the aircraft 1 according to the specific mission requirements. The aircraft 1 is placed at an end of the launch arm 3 and is connected to the end of the launch arm 3 with a gimbal.

In the following embodiments of the present disclosure, the rotary launch system for an aircraft 1 is used as the application platform. To simplify the description, the following assumptions are made for the following physical perspective views. It is assumed that the gravity, tension, and aerodynamic force exerted on the aircraft 1 all act on the center of mass o1 of the aircraft 1. In the drawings, a segment of the arm a1 that supports the aircraft 1 passes through o1. At the trimming end, the gravity and aerodynamic force of the aerodynamic driving device 6 act on the center of mass o2, and a segment of the arm a2 that supports the trimming end passes through o2. The attitude adjustment device 6 at both ends do not change the positions of the centers of mass o1 and o2 relative to the arm. Take a fixed-wing aircraft as an example. The center of mass of the aircraft is located at o1, and the longitudinal direction of the fuselage of the aircraft 1 is tangent to the motion trajectory of its center of mass o1. The roll angle of the aircraft 1 is 0, and the pitch angle is 0. During the launch process, the aircraft 1 is subject to the forward thrust Fp and the backward air resistance Fd provided by its own drive, and the combined force of the two is the forward combined force Ff. The aircraft 1 is subject to the upward lift Fu and the downward gravity Fg, and the combined force of the two is Fdw. In the current rotating state, it is subject to the centrifugal force Fcf away from the center of rotation.

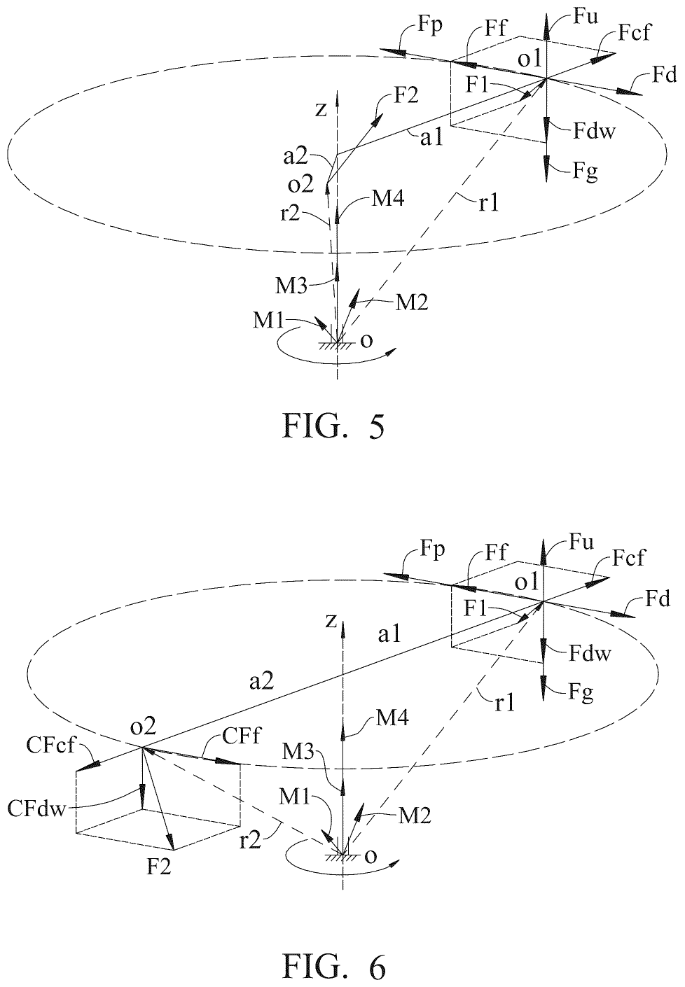

The first implementation of the present disclosure is shown in FIG. 5 and FIG. 6. FIG. 5 is a force analysis diagram in this case; and as a common design scheme, FIG. 6 is a force analysis diagram when the trimming end and the aircraft are symmetrically arranged. The trimming end and the aircraft act concurrently to generate a torque that accelerates the rotation, and the undesirable torque is offset simultaneously. In other words, the direction of the resultant force and the driving torque of the trimming end and the aircraft aligns with the z-axis and has the same direction.

For this implementation, the present disclosure provides the following embodiments.

Embodiment 1, the aerodynamic driving device 6 is implemented by the trimming method using a propeller 61.

In some embodiments, combined with the force analysis shown in FIG. 5, the layout is implemented according to FIG. 1. The thrust Fp of the aircraft 1 is non-zero. The arm of the aircraft 1 is a1, which passes through the center of mass o1 of the aircraft 1. The arm of the propeller 61 is a2, which passes through the center of mass o2 of the propeller 61. Under the force condition of the aircraft 1 as shown in FIG. 5, the propeller 61 is oriented towards F2 and applies a force F2. Then, the torques about point o for the two are M1 and M2, respectively. The sum of the M1 and M2 is M3, which aligns with the z-axis and has the same direction as the driving torque M4 applied by the driver. M3 and M4 together provide torque for the rotating part of the rotary launch system without generating a torque that overturns the rotating system.

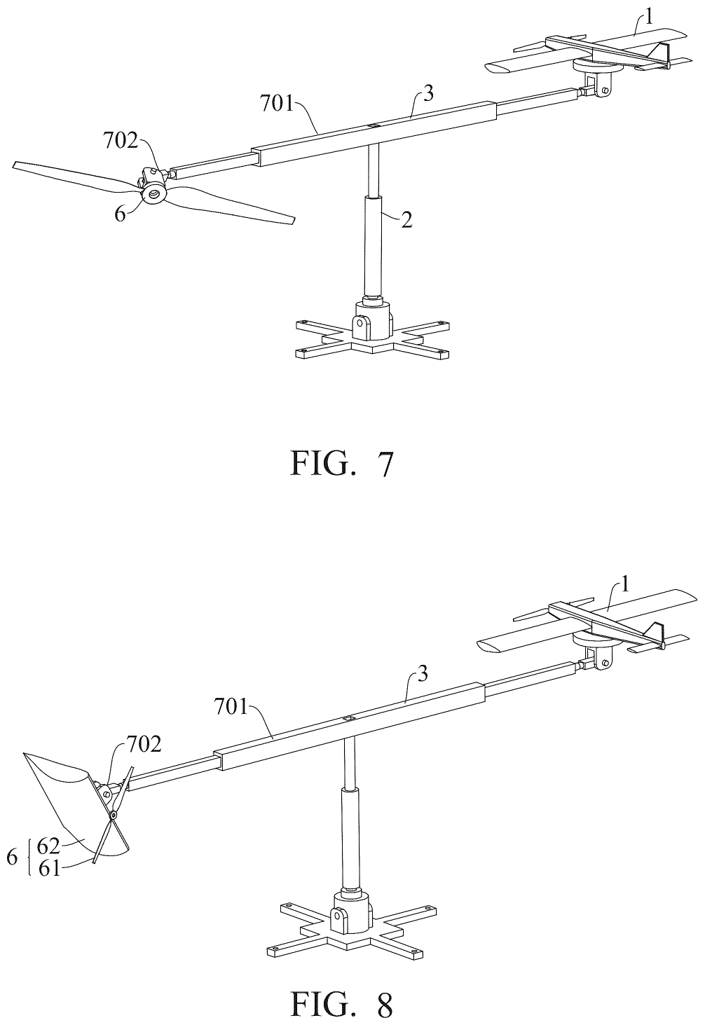

In some embodiments, as a common design scheme, combined with the force analysis shown in FIG. 6, the layout is implemented as shown in FIG. 7. In the rotating launch application as shown in FIG. 7, the trimming arm 701 and the launch arm 3 are designed in the same way and are arranged 180 degrees about the z-axis. Since the effects of the trimming arm 701 and the launch arm 3 on the force application point of the rotating drive during the movement always offset each other on the horizontal plane, for the sake of simplicity, only the effects of the aircraft 1 and the aerodynamic driving device 6 on the force analysis point of the system are analyzed. In some embodiments, the propeller 61 and the attitude adjustment device 702 on the left are configured to trim the aircraft 1 on the right in FIG. 7. The forces on the aircraft 1 are consistent with those shown in FIG. 6, and are not repeated here.

At this time, the control unit 4 combines the information obtained by the sensing system, and obtains the magnitude of the centrifugal force, the vertical resultant force, and the resultant force along the fuselage direction shown in FIG. 6 by calculation or direct measurement. Then, the magnitude and vector direction of F2 as shown in FIG. 6 are obtained, and the angles of each revolute joint of the attitude adjustment device 702 are calculated. The trimming arm 701 and the attitude adjustment device 702 are controlled to make the propeller 61 reach a desired attitude and the propeller 61 generate a thrust F2.

In order to eliminate the adverse torque of various forces on the aircraft 1 to the force analysis point o. The aerodynamic driving device 6 applies a trimming force F2 at the symmetrical action point o2. As shown in FIG. 6, the three directions are respectively the forward trimming force CFf, the vertical trimming force CFdw, and the centrifugal trimming force CFcf. CFf is has the same magnitude and opposite direction as Ff, CFdw has the same magnitude and same direction as Fdw, and CFcf has the same magnitude and opposite direction as Fcf. In this way, the action of the aircraft 1 and the trimming force on the force analysis point o is the moment M1 and M2 as shown in FIG. 6, and the combined moment of the two is M3. M3 is along the z-axis direction, so there is no “adverse torque” on the system. M3 and M4 act together to drive the rotating arm to rotate and then drive the aircraft 1 to be launched, without generating a torque to overturn the rotating system. In some embodiments, the trimming arm 701 uses a telescopic arm rod, which may flexibly configure the position of the aerodynamic driving device 6, and cooperate with the attitude adjustment device 702 to flexibly provide a trimming force. For example, when the maximum output force of the aerodynamic driving device 6 is limited, a larger trimming arm may be obtained by extending the trimming arm to reduce the demand for the output force of the aerodynamic driving device 6. For another example, in Embodiment 2, since the aerodynamic wing surface is related to the linear velocity, at a specific angular velocity, the linear velocity of the aerodynamic wing surface may be adjusted by adjusting the length of the telescopic rod, thereby adjusting its matching force.

The advantage of using the propeller 61 for trimming is that the thrust of the propeller 61 is only limited by its own maximum thrust, and is not affected by the motion state of the rotating launch arm 3, so it may provide effective trimming force under various working conditions of the rotating launch arm 3.

In Embodiment 2, the aerodynamic driving device uses an aerodynamic wing surface 62 and a propeller 61 to jointly generate the force and torque required for trimming.

As shown in FIG. 8, similar to Embodiment 1, the resultant force of the trimming end and the aircraft generated in the present embodiment aligns with the direction of the driving torque. The matching force of the present embodiment is provided by the aerodynamic wing surface 62 and the propeller 61. The aerodynamic wing surface 62 provides the matching force of the centrifugal force and the vertical force, and the propeller 61 maintains the output of the force along the tangent direction of the movement by the attitude adjustment device, providing the matching force of the aircraft 1 along the direction of the fuselage. Since the aerodynamic wing surface 62 generates inaccurate aerodynamic force and is easily affected by the external environment, a certain amount of residual undesirable torque may be generated during implementation. As long as the torque magnitude is within the tolerable range of the system, it is considered acceptable. The direction and tension of the propeller 61 may be adjusted independently in real time to achieve the best effect.

In some embodiments, the propeller 61 in Embodiment 2 is set at a suitable position of the trimming arm 701 through another attitude adjustment device 702. By adjusting the attitude adjustment device 702 and the thrust of the propeller 61, a trimming force equivalent to the propeller 61 in Embodiment 2 is formed.

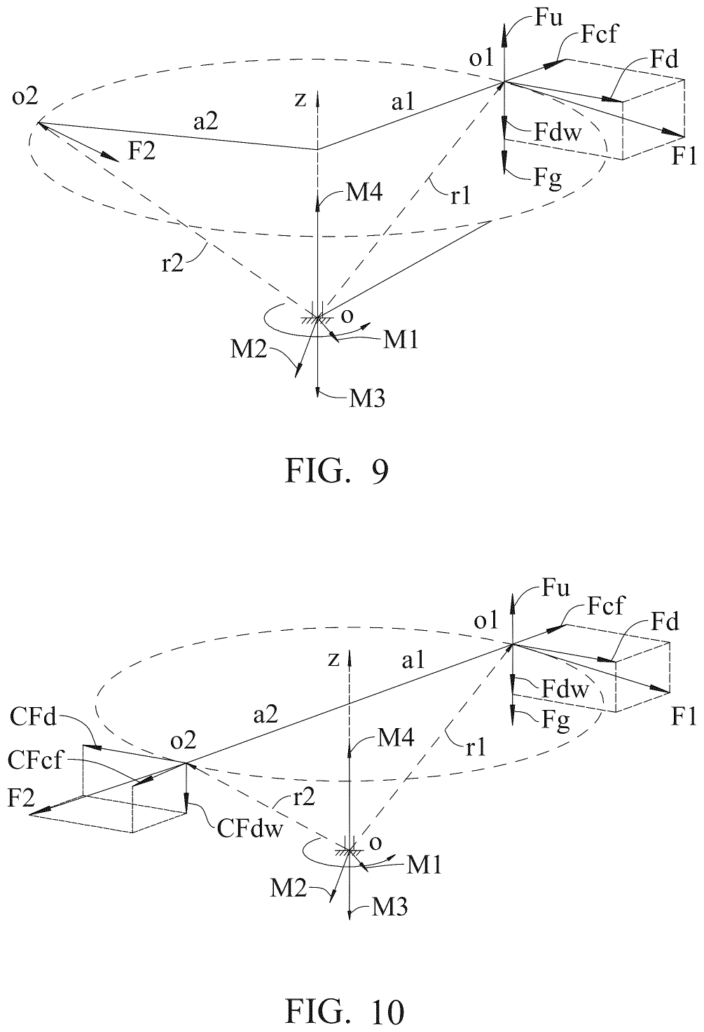

The second implementation of the present disclosure is shown in FIG. 9 and FIG. 10. FIG. 9 is a force analysis diagram in the present implementation; and as a common design scheme, FIG. 10 is a force analysis diagram when the trimming end and the aircraft are symmetrically arranged. The trimming end and the aircraft act concurrently to produce a torque in the opposite direction of the driving torque, resulting the “bad” torque to be offset. That is, the trimming result produces a pure reverse torque. For the convenience of expression, compared with the scenario in FIG. 5, the thrust Fp of the aircraft 1 is 0, and the other forces remain unchanged. Then the resultant force on the aircraft is F1 as shown in FIG. 9. When the trimming force is applied to the trimming end, the corresponding F2 is applied. In the present implementation, Embodiment 3 is provided, in which the aerodynamic driving device 6 uses a propeller 61 to generate the force and torque required for trimming.

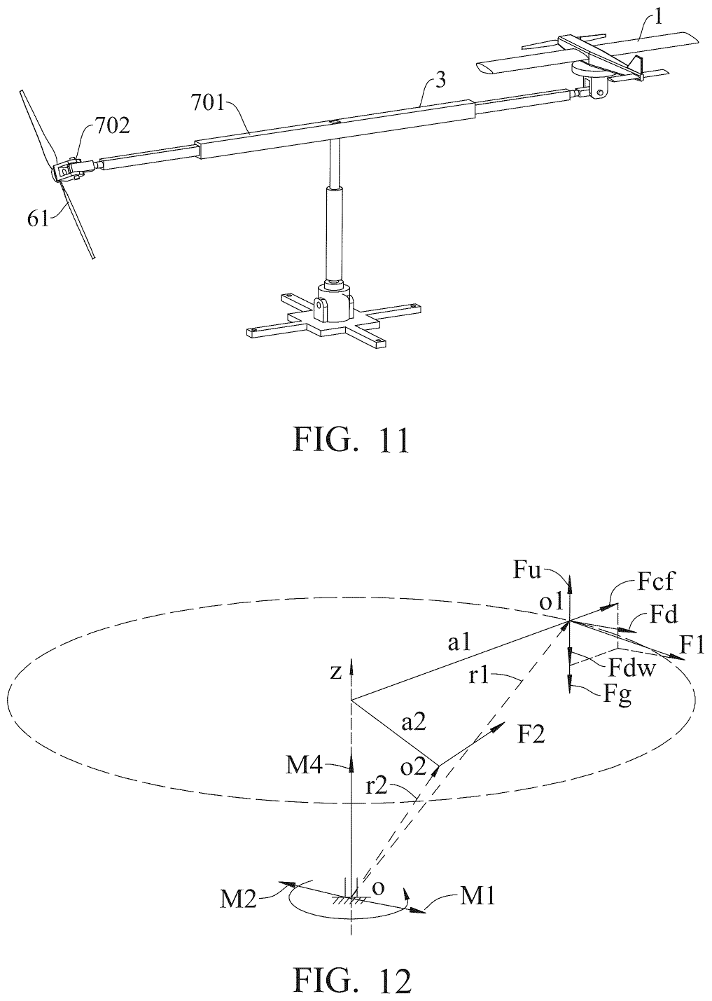

As shown in FIG. 11, based on embodiment 1, the driver of the aircraft 1 is not started, and the driving torque required for the rotating part of the launch system comes entirely from the driving device. The force of the system is shown in FIG. 10. The control unit 4 controls the trimming arm 701 and the attitude adjustment device 702 to make the propeller 61 reach a desired attitude, allowing the propeller 61 to generate a thrust F2. The components of F2 are: CFd, CFcf, and CFdw. They are equal in magnitude but in opposite directions to the air resistance Fd and the centrifugal force Fcf on the aircraft, respectively. They are equal in magnitude and in the same direction to the vertical resultant force Fdw on the aircraft. The trimming force and the torque applied by the aircraft at o are M2 and M1, and the resultant vector is M3, which is opposite to the driving torque M4 of the driver.

In the third implementation of the present disclosure, the spatial torque of the trimming end and the aircraft acting together on the point is 0. The driving torque required by the system is only provided by the driver of the driving column.

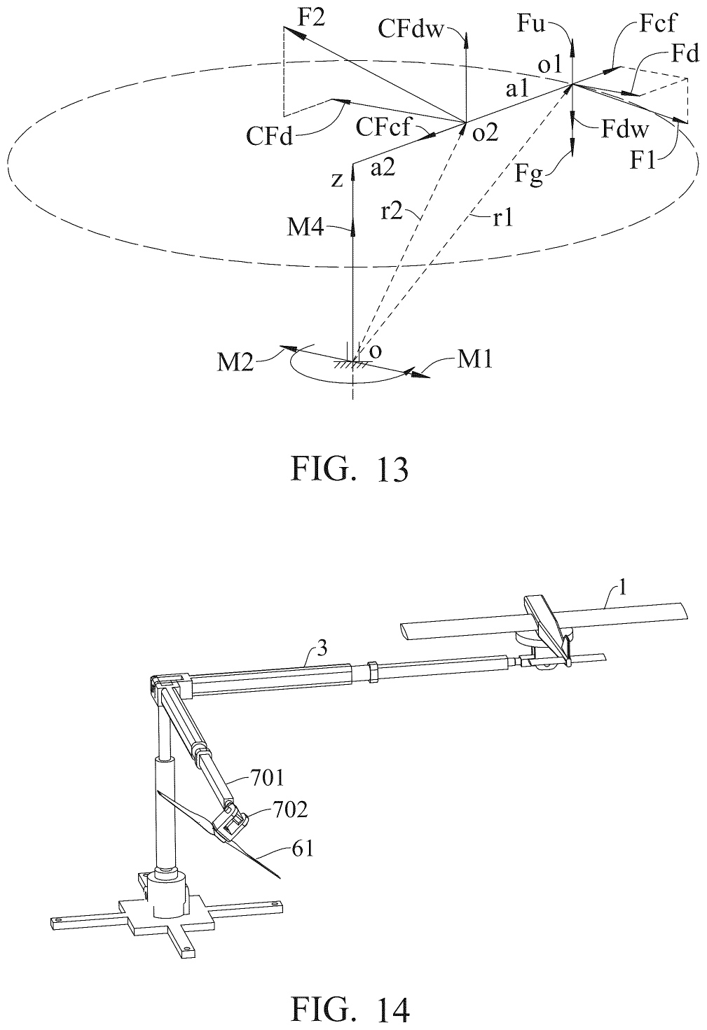

FIG. 12 is a force analysis diagram in the present implementation. As a common design scheme, FIG. 13 is a force analysis diagram when the trimming end and the aircraft are arranged on the same side. In FIG. 12, the point of action o2 of the trimming force may be flexibly set by the trimming arm a2. At this time, the resultant force on the aircraft is F1, and its point of action is o1, forming the torque M1 passing through point o. In order to first calculate the trimming moment M2 when the trimming force point o2 is known, as shown in the present embodiment, the trimming moment M2 is equal to M1 in magnitude and opposite in direction. The trimming force F2 may be found by the calculation method of the spatial moment to achieve the trimming of the aircraft.

For the present implementation, the present disclosure provides the following embodiments.

Embodiment 4, as shown in FIG. 14, the aerodynamic driving device 6 adopts a propeller 61. The control unit 4 controls the trimming arm 701 and the attitude adjustment device 702 to make the propeller 61 reach a desired attitude, allowing the propeller 61 to generate a thrust such as F2 in FIG. 12.

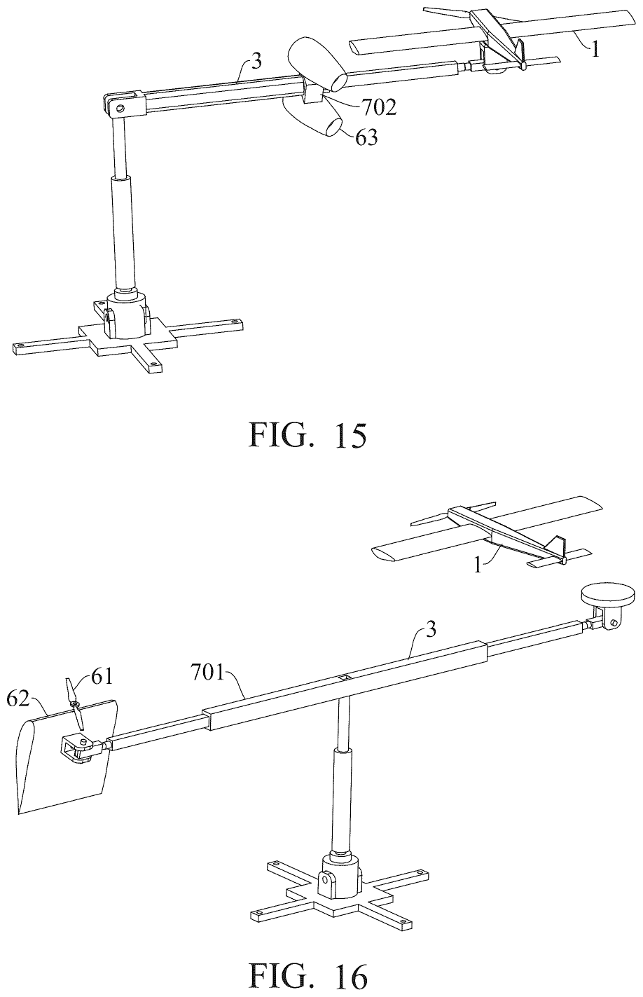

Embodiment 5, as shown in FIG. 15, the aerodynamic driving device 6 is arranged on the launch arm 3. The control unit 4 controls the attitude adjustment device 702 to make the aerodynamic driving device 6 reach the desired attitude, allowing the aerodynamic driving device 6 to generate a thrust F2. In the present embodiment, the aerodynamic driving device 6 uses a jet power device 63 to achieve the force required for trimming. The action point of the jet power device 63 is set at the midpoint of the launch arm 3. The jet power orients to the direction of F2 and generates an aerodynamic force the same as the magnitude of F2 to achieve the trimming effect described in FIG. 13.

For the convenience of description, it is assumed that the action point o2 of the trimming force is at the midpoint between the action point o1 at the aircraft and the rotation center. The vertical component force CFdw of F2 is opposite to the direction of Fdw at the aircraft, and its magnitude is twice that of the latter. The forward component force CFd of F2's motion direction is opposite to the direction of Fd at the aircraft, and its magnitude is twice that of the latter. The component force CFcf of F2 along the rotation radius direction is equal to Fcf at the aircraft in magnitude and opposite in direction. In this way, the trimming moment M2 may be obtained to offset the moment M1 of the aircraft on point o. For the present implementation, the present disclosure provides the following embodiments.

Embodiment 6, the launch system is at rest, or in a low-speed stage and there is no assistance from the engine of the aircraft 1. Centrifugal force and air resistance are negligible. The aerodynamic driving device 6 applies a symmetrical vertical downward trimming force at another end, and M32 is 0.

The aerodynamic devices in all the above embodiments are only configured as examples. In actual applications, the aerodynamic device needs to select one or more combinations of the aerodynamic driving devices 6 listed in the above embodiments and those not listed according to actual conditions. In actual applications, the aerodynamic driving device 6 and the trimming arm 701 may be configured for implementation; or, the aerodynamic driving device 6, the trimming arm 701 and the attitude adjustment device 702 may be configured for implementation.

After the aircraft in any of the above embodiments is separated from the launch system, the trimming end needs to be re-trimmed. In some embodiments, the trimming end state may be adjusted to quickly decelerate the rotating part of the launch system. As shown in FIG. 16, for the trimming end that generates force using system rotation, the aerodynamic attitude adjustment device 702 may be quickly adjusted to allow its larger surface to face the direction of the relative airflow, thus quickly braking the rotating part of the launch system.

Compared to the related art, the present disclosure offers at least the following advantages.

Lightweight: Due to the high thrust-to-weight ratio of the aerodynamic components (e.g., the propeller may achieve ratios of several tens), the overall system weight is significantly reduced.

The point of force is located far from the target moment center (e.g., rotation axis), effectively minimizing residual moments and reducing structural strength requirements.

Unlike mass-trimming methods, this system eliminates the coupling between centrifugal force and gravity-induced torque. It may independently generate suitable trimming forces and moments in both aspects simultaneously.

The system may quickly adapt to changes in required trimming forces. Rotational launch systems typically experience abrupt force changes before and after launch. The aerodynamic force adjustment system may rapidly alter the attitude, power input to the drive source, or the state of the aerodynamic components, enabling swift compensation for sudden force changes in the trimmed part of the system.

It provides additional capabilities, such as supplying the driving force needed for rotation or the braking force required for deceleration of the rotational launch system. For instance, it may apply braking force to rapidly bring the rotating system from a high launch speed down to zero.

The aerodynamic trimming components may be effectively integrated to maintain structural compactness with other system parts, facilitating easy folding and transportation of the system.

The present disclosure provides an aerodynamic force-based force adjustment system and method for a rotating body. This force adjustment system employs aerodynamic components to supply the required trimming force and trimming moment. Since the aerodynamic components are positioned at the ends of the rotating arms and are relatively distant from the rotation center, they may effectively generate the trimming force and moment. Furthermore, aerodynamic components typically possess a high thrust-to-weight ratio, enabling substantial driving force with minimal added weight, thereby achieving significant system weight reduction and enhancing foldability for storage and transport. Owing to their adjustable thrust direction, these components may also provide the system with additional propulsion and braking capabilities.

Although the embodiments of the present disclosure have been shown and described, it will be appreciated by those skilled in the art that various changes, modifications, substitutions and variations may be made to the embodiments without departing from the principles and spirit of the present disclosure, and that the scope of the present disclosure is defined by the appended claims and their equivalents.

What is claimed is:

1. A system for adjusting forces acting on a rotating body using aerodynamic means, comprising:
an aerodynamic component comprising at least one support component, the at least one support component comprising at least one aerodynamic driving device;
a state sensing system configured to obtain a motion state of the system; and
a control unit, the aerodynamic component and the state sensing system being respectively electrically connected to the control unit, and the control unit configured to control the aerodynamic component to reach a desired state according to information obtained by the state sensing system.

2. The system according to claim 1, wherein the at least one support component further comprises an attitude adjustment device with at least one degree of freedom, the aerodynamic driving device is arranged on the attitude adjustment device, and the attitude adjustment device is configured to adjust an attitude of the at least one aerodynamic driving device.

3. The system according to claim 2, wherein the attitude adjustment device comprises a first connecting rod and a second connecting rod connected in sequence by a revolute joint; the first connecting rod is provided with a first revolute joint, an axis of the first revolute joint is the radial direction of a rotation center, the first connecting rod and the second connecting rod are connected by a second revolute joint, and an axis of the second revolute joint is perpendicular to the axis of the first revolute joint;
the at least one aerodynamic driving device is arranged on the second connecting rod;
the first revolute joint and the second revolute joint are actuated by servo drive, a mechanical linkage, or a combination of the servo drive and the mechanical linkage.

4. The system according to claim 3, wherein the attitude adjustment device further comprises a third connecting rod, the second connecting rod and the third connecting rod are connected by a third revolute joint, an axis of the third revolute joint is perpendicular to the axis of the second revolute joint, and the at least one aerodynamic driving device is arranged on the third connecting rod; and
the third revolute joint is driven by the servo drive or the mechanical linkage or a combination of the servo drive and the mechanical linkage.

5. The system according to claim 1, wherein the support component comprises a support body, and the at least one aerodynamic driving device is mounted on the support body.

6. The system according to claim 5, wherein the support body is configured to selectively rotate about a rotation center.

7. The system according to claim 1, wherein the at least one aerodynamic driving device is configured to selectively reciprocating along a radial direction relative to a rotation center.

8. The system according to claim 1, wherein the at least one aerodynamic driving device is configured to selectively swing about a rotation center.

9. The system according to claim 1, wherein the state sensing system further comprises an environmental information sensing system, the environmental information sensing system is electrically connected to the control unit, and the environmental information sensing system is configured to obtain environmental information of the system.

10. A method for adjusting a force on a rotating body, the method comprising,
rotating the system about a rotation axis;
obtaining state information of a force and/or torque of the system on a force monitoring point in response to the system;
performing a force analysis on the state information to obtain dynamic information for adjustment;
sending the dynamic information to an aerodynamic component to allow the aerodynamic component to reach a desired attitude and generate the desired force and/or torque;
adjusting an undesirable torque on at least a part of the system in response to the system being in the rotating state.

11. The method according to claim 10, wherein the aerodynamic component has a driving force,
and the aerodynamic component is configured to adjust undesirable torque of the at least a part of the system in response to the system being the rotating state, and provide the driving force to enable the system to rapidly reach a desired acceleration speed in response to the system being in an accelerated rotating state.

12. The method according to claim 10, further comprising:
performing a force analysis on the state information and obtaining required braking information in response to the system needing to decelerate;
sending the braking information to the aerodynamic component to allow the aerodynamic component to reach the desired attitude and generate the desired force and/or torque;
offsetting the undesirable torque of the at least a part of the system in the rotating state, and
providing a braking force to decelerate the system.
